(19) United States
(12) Patent Application Publication
(10) Pub. No.: US 2020/0170436 A1
(43) Pub. Date: Jun. 4, 2020

(54) ELECTRIC COOKER WITH STIRRING FUNCTION

(71) Applicant: Zhejiang Puliyuan Plumbing Technology Co., Ltd., Zhejiang (CN)

(72) Inventor: Shihong HAN, Zhejiang (CN)

(73) Assignee: Zhejiang Puliyuan Plumbing Technology Co., Ltd., Zhejiang (CN)

(21) Appl. No.: 16/699,135

(22) Filed: Nov. 29, 2019

(30) Foreign Application Priority Data
Nov. 29, 2018 (CN) 201811440282.1

(51) Int. Cl. A47J 27/00; A47J 36/16

(52) U.S. Cl. CPC A47J 27/004; A47J 27/002; A47J 36/165

(57) ABSTRACT

The present invention discloses an electric cooker with a stirring function, and relates to a household appliance. The main points of the technical solution are as follows. The electric cooker comprises a housing, wherein an inner pot and a heating device are disposed in the housing, a stirring shaft is rotatably disposed in the housing, the stirring shaft penetrates through the inner pot and forms rotary sealing, a stirrer is disposed on the stirring shaft positioned in the inner pot, a driven pulley is further fixed on the stirring shaft. The electric cooker is provided with the stirrer, so that food in cooking can be stirred, the cooking effect is better, and the electric cooker is particularly suitable for being used in Africa.

### CROSS-REFERENCE TO RELATED APPLICATION

This application claims the priority benefit of China application serial no. 201811440282.1, filed on Nov. 29, 2018. The entirety of the above-mentioned patent application is hereby incorporated by reference herein and made a part of this specification.

### BACKGROUND

### Technical Field

The present invention relates to a household appliance, in particular to an electric cooker with a stirring function.

### Description of Related Art

The electric cooker is a common electric appliance for cooking at home, and can be used for cooking soup, porridge or thick soup besides cooking rice.

The current Chinese utility model patent with authorized publication number CN203424813U discloses an electric cooker, comprising a middle frame disposed on a base and a cooker cover assembly disposed on the middle frame, wherein an outer pot is fixed in the middle frame, a heating plate and a cooker bottom sensor are disposed below the outer pot, an inner pot is disposed in the outer pot, and an electric control device is further disposed at a front end of the middle frame.

The above-mentioned solution in the prior art has the following defects: when the electric cooker is used for cooking thick soup or soup, water and various food materials are placed in the electric cooker, especially when food materials for the African meals are cooked, the fluidity of water and food materials in the electric cooker is poor, and the food materials may be delaminated or adhered to the bottom of the cooker, so that partial scorching or non-uniform degree of cooking may be caused, and the cooking effect is relatively poor. Therefore, manual stirring is generally needed during cooking of the food materials, thereby being very inconvenient.

### SUMMARY

Aiming at the defects in the prior art, an object of the present invention is to provide an electric cooker with a stirring function, which is capable of automatically stirring food in the cooker, so that the manual labor is less and the cooking effect is good.

The above technical object of the present invention is achieved through the following technical solution. An electric cooker with a stirring function comprises a housing, wherein an inner pot and a heating device for heating the inner pot are disposed in the housing, a stirring shaft is rotatably disposed in the housing, the stirring shaft penetrates through a bottom of the inner pot and forms rotary sealing with the inner pot, a stirrer is disposed on the stirring shaft positioned in the inner pot, a driven pulley is coaxially fixed on the stirring shaft positioned below the inner pot, a motor is disposed on a radial side of the inner pot in the housing, a driving pulley is coaxially fixed at an output end of the motor, and the driving pulley and the driven pulley form transmission by tensioning a transmission belt disposed between the driving pulley and the driven pulley.

Through the above technical solution, when the electric cooker is used for cooking food materials and soup, the food materials and water are put into the inner pot, and after the heating device is electrified, the heating device heats to cook food. Meanwhile, a user can start the motor, the motor drives the stirring shaft to rotate through the driving pulley, the transmission belt and the driven pulley, the stirring shaft drives the stirrer to rotate in the food, so as to achieve a stirring effect on the water and the food materials, and the motor can be frequently switched to rotate forwards and reversely, so as to enhance the stirring effect. Therefore, the food materials are unlikely to delaminate or adhere to the bottom of the cooker, heating for the food materials is relatively uniform, and the cooking effect is better. Moreover, the rotation of the stirrer is automatically completed by the motor, so that the amount of manual labor is less.

The rotating speed output by the motor is generally relatively high, the size of the driving pulley is set to be smaller than that of the driven pulley, and the combination of the driving pulley with the smaller size and the driven pulley with the larger size can achieve a speed reduction effect, so that the stirrer can rotate forwards or reversely at a proper speed. As the electric cooker has higher applicability to the motor, it is unnecessary to employ a motor at a low rotational speed or with a speed reducer. The motor disposed on the radial side of the inner pot does not occupy the space below the inner pot, and the transmission belt and the driven pulley can be set to be relatively thin, so that the overall height of the electric cooker can be set to be less. An operating panel of the electric cooker can be disposed above the motor, and the motor is relatively hidden in position, so that the electric cooker further has the advantages of being compact in structure and small in occupied space.

Preferably, a first connecting piece is disposed at an end, facing towards the driven pulley, of the stirring shaft, and a plurality of force transmission rods are disposed on the first connecting piece along a circumferential direction. A second connecting piece is coaxially disposed on the driven pulley towards the stirring shaft, and a plurality of force transmission grooves in which the force transmission rods are embedded are formed in the second connecting piece. The stirring shaft and the driven pulley are spliced through the first connecting piece and the second connecting piece to achieve disassembling and assembling and torque transmission.

Through the above technical solution, the stirring shaft and the driven pulley are spliced through the first connecting piece and the second connecting piece to achieve torque transmission. As the first connecting piece and the second connecting piece can be disengaged conveniently, the user can take the inner pot out of the housing, and then can move the inner pot to be near food materials or a water source, so as to put the food materials and water into the inner pot conveniently.

Preferably, the force transmission rods are distributed in a circumferential array relative to an axis of the first connecting piece, and a number of the force transmission rods is at least two. The force transmission grooves are distributed in a circumferential array relative to an axis of the second connecting piece, and a number of the force transmission grooves is an integral multiple and at least double of the number of the force transmission rods.

Through the above technical solution, as the force transmission rods are distributed in the circumferential array relative to the axis of the first connecting piece, the center of gravity of the first connecting piece is positioned on the axis thereof, and the stability of the connecting piece is high during rotation. As the number of the force transmission grooves is at least double of that of the force transmission rods, spacing between the adjacent force transmission grooves is less, and the force transmission rod can be spliced with the adjacent force transmission groove by rotating at a relatively small angle, thereby being relatively fast. On this basis, when the number of the force transmission grooves is larger, the width of the notches of the force transmission grooves can be set to be less, so as to decrease knocking forces between the force transmission rods and walls of the force transmission grooves when the motor is started.

Preferably, a plurality of connecting sheets are fixed on the second connecting piece along a circumferential direction, and the force transmission grooves are formed between the adjacent connecting sheets. Two sides of an end, facing towards the inner pot, of each of the connecting sheets are respectively provided with a guide surface, the guide surfaces on the same connecting sheet are connected through edges. When the force transmission rods are in contact with the guide surfaces, the guide surfaces guide the force transmission rods to be embedded into the force transmission grooves.

Through the above technical solution, when the first connecting piece moves towards the direction of the second connecting piece, the inclined guide surfaces can drive the force transmission rods to rotate, so that the force transmission rods are reliably embedded into the force transmission grooves. As the guide surfaces on the same connecting sheet are connected through edges, the force transmission rods can be reliably spliced with the force transmission grooves regardless of the relative positions thereof, thereby greatly reducing manual alignment difficulty.

Preferably, a first fixing piece is disposed on the inner pot towards the driven pulley, and a plurality of inserting blocks are disposed on the first fixing piece along a circumferential direction. A second fixing piece is disposed on the housing towards the first fixing piece, first inserting grooves are formed in the second fixing piece corresponding to the inserting blocks, and movement of the first fixing piece allows the inserting blocks to be inserted into the first inserting grooves, so as to limit rotation of the inner pot relative to the housing.

Through the above technical solution, the first fixing piece can insert the inserting blocks into the first inserting grooves by moving to limit the rotation of the inner pot relative to the housing while the first connecting piece is spliced with the second connecting piece, thereby improving the stability of the inner pot installed in the housing.

Preferably, second inserting grooves are formed in bottoms of the first inserting grooves, and depth directions of the second inserting grooves are along a circumferential direction of the second fixing piece. Rotation of the first fixing piece allows the inserting blocks to be inserted into the second inserting grooves, so as to limit the disengagement of the inner pot from the housing.

Through the above technical solution, on the premise that the inserting blocks are completely inserted into the first inserting grooves, the user can insert the inserting blocks into the second inserting grooves by rotating the inner pot to limit the disengagement of the inner pot from the housing, thereby further improving the stability of the inner pot installed in the housing, and being relatively convenient to disassemble and assemble.

Preferably, notches of the first inserting grooves are flared.

Through the above technical solution, the flared first inserting grooves can be convenient for the user to align the inserting blocks with and insert the inserting blocks into the first inserting grooves.

Preferably, the stirrer and the stirring shaft are detachably connected in a splicing manner through a spline shaft.

Through the above technical solution, the stirrer and the stirring shaft connected through the spline shaft can reliably transmit torque, and when the stirrer is pulled outwards, the stirrer can be conveniently disengaged from the stirring shaft. The stirrer is pulled out after cooking is finished, so that the user can conveniently take food out of the inner pot.

Preferably, a pull ring convenient for a person to pull out the stirrer is fixed at an end, facing away from the stirring shaft, of the stirrer.

Through the above technical solution, the user can conveniently disengage the stirrer from the stirring shaft by pulling the pull ring.

Preferably, the transmission belt is a synchronous belt, and both the driving pulley and the driven pulley are synchronous pulleys matched with the transmission belt.

Through the above technical solution, compared with a common belt, transmission with the synchronous belt has the advantages of being unlikely to slip and accurate in transmission angle.

In summary, compared with the prior art, the present invention has the following beneficial effects.
1. By disposing the stirrer, food in cooking can be stirred, so that the cooking effect is better, and the electric cooker is especially suitable for use in Africa.
2. The stirrer is driven by the motor to automatically rotate, so that the amount of manual labor is less.
3. The electric cooker has the advantages of being compact in structure and small in occupied space while having the stirring function.
4. The inner pot can be conveniently disassembled and assembled with the housing, and the stability of the inner pot is high after installation.

### BRIEF DESCRIPTION OF THE DRAWINGS

FIG. 1 is a three-dimensional view of an electric cooker with a stirring function according to examples, mainly highlighting an external structure of the electric cooker;

FIG. 2 is a sectional view of the electric cooker with the stirring function according to the examples, mainly highlighting an internal structure of the electric cooker;

FIG. 3 is a partial exploded view of the electric cooker, mainly highlighting structures of a second fixing piece and a second connecting piece; and

FIG. 4 is another partial exploded view of the electric cooker, mainly highlighting structures of a first fixing piece and a first connecting piece.

In the figures, 1. housing; 2. inner pot; 11. end cover; 12. heating device; 21. stirrer; 13. motor; 22. stirring shaft; 211. pull ring; 3. first connecting piece; 31. force transmission rod; 4. first fixing piece; 41. inserting block; 5. second fixing piece; 51. first inserting groove; 52. second inserting groove; 53. elastic gasket; 6. driven shaft; 61. second connecting piece; 62. driven pulley; 611. connecting sheet; 612. force transmission groove; 613. guide surface; 121. driving pulley; and 7. transmission belt.

### DESCRIPTION OF THE EMBODIMENTS

The present invention will now be described in further detail with reference to the accompanying drawings.

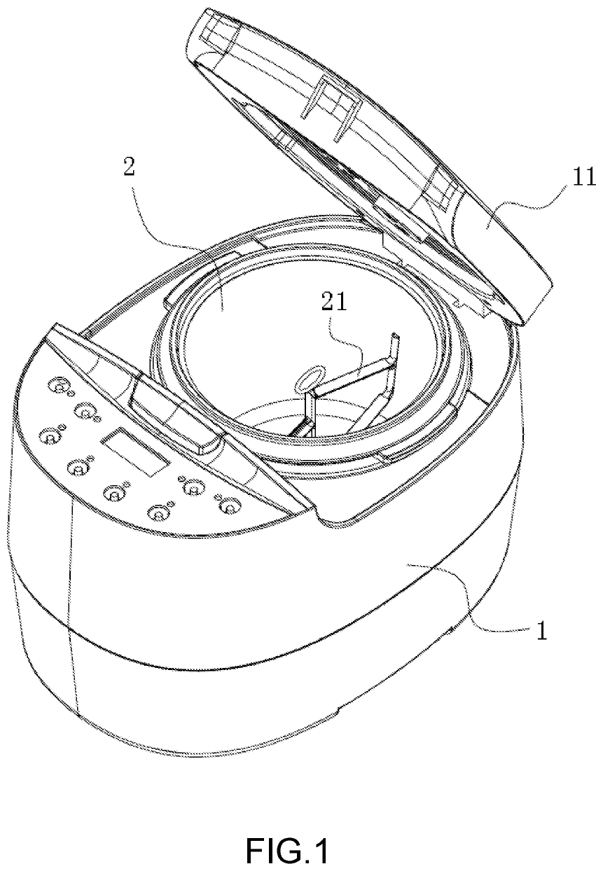

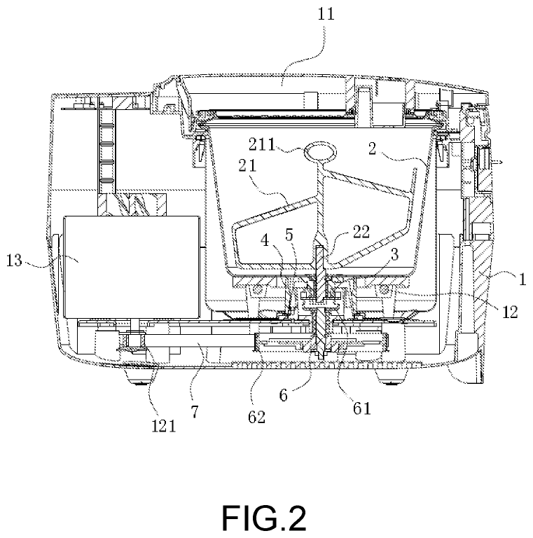

Referring to FIG. 1 and FIG. 2, an electric cooker with a stirring function disclosed by the present invention comprises a housing 1, wherein an inner pot 2 used for placing food is disposed in the housing 1, an end cover 11 used for closing the inner pot 2 is articulated on the housing 1, a heating device 12 is disposed at an outer bottom of the inner pot 2, and the heating device 12 is fixed on the housing 1. The heating device 12 is a copper tube through which a heating wire penetrates, and by electrifying the heating wire, a temperature of the heating device 12 can be raised and heat can be conducted to the inner pot 2 for cooking food. A stirrer 21 is rotatably disposed in the inner pot 2, and the stirrer 21 is driven by a motor 13 fixed in the housing 1 to rotate.

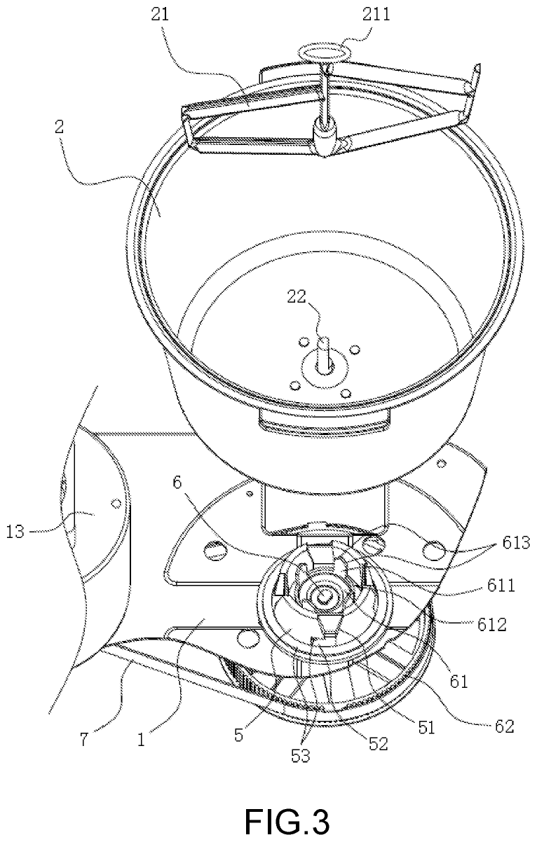

Referring to FIG. 2 and FIG. 3, a stirring shaft 22 is rotatably disposed in the inner pot 2, the stirring shaft 22 perpendicularly penetrates through a bottom of the inner pot 2, the stirring shaft 22 forms rotary sealing with the inner pot 2 through a sealing gasket, and the stirring shaft 22 is positioned at the center of the inner pot 2. An end, positioned in the inner pot 2, of the stirring shaft 22 is used for being connected with the stirrer 21, and the stirrer 21 and the stirring shaft 22 are detachably connected in a splicing manner through a spline shaft, wherein a key groove is positioned in the stirring shaft 22, the key groove is communicated with an end, facing towards the stirrer 21, of the stirring shaft 22, and the stirrer 21 slides along an axial direction of the stirring shaft 22 to complete disassembling and assembling with the stirring shaft 22. The stirrer 21 is of a frame-shaped structure, and a pull ring 211 convenient for a person to pull out the stirrer 21 is fixed at an end, facing away from the stirring shaft 22, of the stirrer 21.

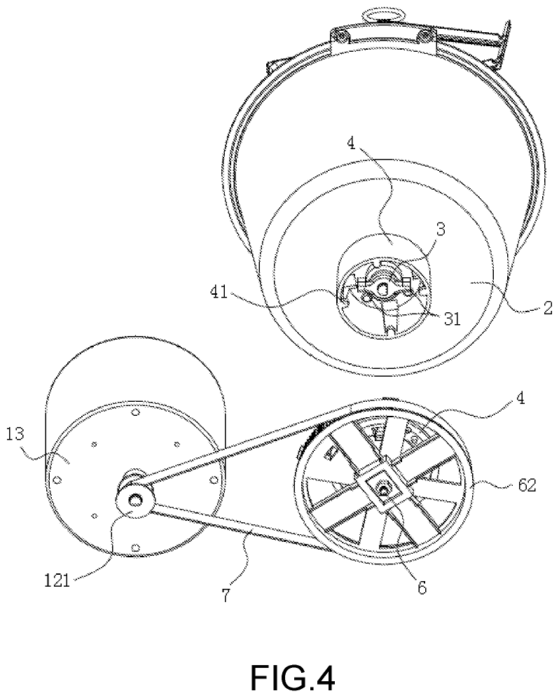

Referring to FIG. 3 and FIG. 4, a first connecting piece is coaxially fixed at an end, positioned below the inner pot 2, of the stirring shaft 22, two force transmission rods 31 are disposed on the first connecting piece along a circumferential direction, and the two force transmission rods 31 are distributed in a circumferential array relative to an axis of the first connecting piece 3, so that the center of gravity of the first connecting piece 3 is positioned on the axis thereof, and the stability of the connecting piece during rotation is high. A first fixing piece 4 is fixed at a bottom of the inner pot 2, the first fixing piece 4 is cylindrical, an axis of the first fixing piece 4 coincides with the axis of the inner pot 2, and the first connecting piece 3 is integrally positioned inside the first fixing piece 4. The inner pot 2 can be stably placed on a table top through the first fixing piece 4. A plurality of inserting blocks 41 are distributed in a circumferential array on an inner wall of the first fixing piece 4.

A second fixing piece 5 is fixed below the inner pot 2 on the housing 1, and the second fixing piece 5 is used for being matched and fixed with the first fixing piece 4. The second fixing piece 5 is also cylindrical, and the first fixing piece 4 can be sleeved outside the second fixing piece 5 through the inner wall to form initial positioning. First inserting grooves 51 in which inserting blocks 41 are spliced are formed in positions, corresponding to the inserting blocks 41, on the second fixing piece 5, and depth directions of the first inserting grooves 51 are along an axial direction of the second fixing piece 5. The first fixing piece 4 can insert the inserting blocks 41 into the first inserting grooves 51 by moving to limit the rotation of the inner pot 2 relative to the housing 1. Second inserting grooves 52 are formed in bottoms of the first inserting grooves 51, depth directions of the second inserting grooves 52 are along a circumferential direction of the second fixing piece 5, and are the same pointer direction of the second fixing piece 5. On the premise that the inserting blocks 41 are completely inserted into the first inserting grooves 51, a user can insert the inserting blocks 41 into the second inserting grooves 52 by rotating the inner pot 2 to limit the disengagement of the inner pot 2 from the housing 1, so as to complete the installation and fixation of the inner pot 2 and the housing 1. Notches of the first inserting grooves 51 are flared, so as to be convenient for the user to align the inserting blocks 41 with and insert the inserting blocks 41 into the first inserting grooves 51. Elastic gaskets 53 are disposed at positions, used for abutting against an end surface of the first fixing piece 4, on walls of the second inserting grooves 52 and the second fixing piece 5. After the first fixing piece 4 and the second fixing piece 5 are installed, elastic forces of the elastic gaskets 53 can play a role of preventing the first fixing piece 4 and the second fixing piece 5 from loosening. The first fixing piece 4 and the second fixing piece 5 are simple and convenient to disassemble and assemble, and high in stability, and the inner pot 2 is unlikely to move spontaneously on the housing 1.

A driven shaft 6 is rotatably disposed in the second fixing piece 5, and an axis of the driven shaft 6 coincides with an axis of the stirring shaft 22. A second connecting piece 61 is coaxially fixed at one end of the driven shaft 6, and the second connecting piece 61 is used for achieving disassembling and assembling and transmitting torque with the first connecting piece 3. A driven pulley 62 is coaxially fixed at the other end of the driven shaft 6.

Four connecting sheets 611 are fixed on the second connecting piece 61 along a circumferential direction, the four connecting sheets 611 are distributed in a circumferential array relative to an axis of the second connecting piece 61, length directions of the connecting sheets 611 face towards the inner pot 2, spacing is kept between the adjacent connecting sheets 611 to form force transmission grooves 612 in which the force transmission rods 31 are embedded, and a number of the force transmission grooves 612 is also four. Two sides of an end, facing towards the inner pot 2, of each of the connecting sheets 611 are respectively provided with an inclined guide surface 613, and the guide surfaces 613 on the same connecting sheet 611 are connected through edges, so that the ends of the connecting sheets 611 are sharp. When the first connecting piece 3 moves towards the direction of the second connecting piece 61, the inclined guide surfaces 613 can drive the force transmission rods 31 to rotate, so that the force transmission rods 31 are reliably embedded into the force transmission grooves 612. The force transmission rods 31 can be reliably spliced with the force transmission grooves 612 regardless of the relative positions thereof, thereby greatly reducing manual alignment difficulty. As the number of the force transmission grooves 612 is double of that of the force transmission rods 31, the force transmission rod 31 can be spliced with the adjacent force transmission groove 612 by rotating at a relatively small angle, thereby being relatively fast.

Referring to FIG. 2 and FIG. 4, the motor 13 is disposed on a radial side of the inner pot 2, the motor 13 can be switched to rotate forwards and reversely, an output end of the motor 13 is vertically downward and is coaxially fixed with a driving pulley 121, the size of the driving pulley 121 is smaller than that of the driven pulley 62, and the driving pulley 121 and the driven pulley 62 form transmission by tensioning a transmission belt 7 disposed between the driving pulley 121 and the driven pulley 62. The transmission belt 7 is a synchronous belt, and both the driving pulley 121 and the driven pulley 62 are synchronous pulleys matched with the transmission belt 7. Compared with a common belt, transmission with the synchronous belt has the advantages of being unlikely to slip and accurate in transmission angle.

The working conditions of the electric cooker for cooking food materials and soup are as follows. After the end cover 11 is opened, the user can slide the inserting blocks 41 into a first groove by rotating the inner pot 2 and then pull the inner pot 2 outwards to complete disengagement of the inner pot 2 from the housing 1, and then can move the inner pot 2 to be near the food materials or a water source, so as to put the food materials and water into the inner pot 2 conveniently. After the inner pot 2 contains the food materials and water, the user puts the inner pot 2 back into the housing 1, and covers the end cover 11 to prepare for cooking.

After the heating device 12 is electrified, the heating device 12 heats to cook food, and meanwhile, the user can start the motor 13, the motor 13 rotates in a direction in which the motor 13 drives the inserting blocks 41 to abutting against the bottoms of the second inserting grooves 52. The motor 13 drives the driven shaft 6 to rotate through the driving pulley 121, the transmission belt 7 and the driven pulley 62, the driven shaft 6 then drives the stirring shaft 22 to rotate through the second connecting piece 61 and the first connecting piece 3, and the stirring shaft 22 drives the stirrer 21 to rotate in the food, so as to achieve a stirring effect on the water and the food materials, so that the food materials are unlikely to delaminate or adhere to the bottom of the cooker, heating for the food materials is relatively uniform, and the cooking effect is better. Moreover, the rotation of the stirrer 21 is automatically completed by the motor 13, so that the amount of manual labor is less.

The rotating speed output by the motor 13 is generally relatively high, and the combination of the driving pulley 121 with a smaller size and the driven pulley 62 with a larger size can achieve a speed reduction effect, so that the stirrer 21 can rotate at a proper speed. As the electric cooker has higher applicability to the motor 13, it is unnecessary to employ a motor 13 at a low rotational speed or with a speed reducer. The motor 13 disposed on the radial side of the inner pot 2 does not occupy the space below the inner pot 2, and the transmission belt 7 and the driven pulley 62 can be set to be relatively thin, so that the overall height of the electric cooker can be set to be less. An operating panel of the electric cooker can be disposed above the motor 13, and the motor 13 is relatively hidden in position, so that the electric cooker further has the advantages of being compact in structure and small in occupied space.

The examples of the embodiments are all preferred embodiments of the present invention, and are not intended to limit the scope of protection of the present invention. Therefore, any equivalent variation made in accordance with the structure, shape and principle of the present invention shall fall within the scope of protection of the present invention.

What is claimed is:

1. An electric cooker with a stirring function, comprising a housing (1), wherein an inner pot (2) and a heating device (12) for heating the inner pot (2) are disposed in the housing (1), characterized in that a stirring shaft (22) is rotatably disposed in the housing (1), the stirring shaft (22) penetrates through a bottom of the inner pot (2) and forms rotary sealing with the inner pot (2), a stirrer (21) is disposed on the stirring shaft (22) positioned in the inner pot (2), a driven pulley (62) is coaxially fixed on the stirring shaft (22) positioned below the inner pot (2), a motor (13) is disposed on a radial side of the inner pot (2) in the housing (1), a driving pulley (121) is coaxially fixed at an output end of the motor (13), and the driving pulley (121) and the driven pulley (62) form transmission by tensioning a transmission belt (7) disposed between the driving pulley (121) and the driven pulley (62).

2. The electric cooker with the stirring function according to claim 1, characterized in that a first connecting piece (3) is disposed at an end, facing towards the driven pulley (62), of the stirring shaft (22), and a plurality of force transmission rods (31) are disposed on the first connecting piece (3) along a circumferential direction; a second connecting piece (61) is coaxially disposed on the driven pulley (62) towards the stirring shaft (22), and a plurality of force transmission grooves (612) in which the force transmission rods (31) are embedded are formed in the second connecting piece (61); and the stirring shaft (22) and the driven pulley (62) are spliced through the first connecting piece (3) and the second connecting piece (61) to achieve disassembling and assembling and torque transmission.

3. The electric cooker with the stirring function according to claim 2, characterized in that the force transmission rods (31) are distributed in a circumferential array relative to an axis of the first connecting piece (3), and a number of the force transmission rods (31) is at least two; and the force transmission grooves (612) are distributed in a circumferential array relative to an axis of the second connecting piece (61), and a number of the force transmission grooves (612) is an integral multiple and at least double of the number of the force transmission rods (31).

4. The electric cooker with the stirring function according to claim 2, characterized in that a plurality of connecting sheets (611) are fixed on the second connecting piece (61) along a circumferential direction, and the force transmission grooves (612) are formed between the adjacent connecting sheets (611); two sides of an end, facing towards the inner pot (2), of each of the connecting sheets (611) are respectively provided with a guide surface (613), the guide surfaces (613) on the same connecting sheet (611) are connected through edges; and when the force transmission rods (31) are in contact with the guide surfaces (613), the guide surfaces (613) guide the force transmission rods (31) to be embedded into the force transmission grooves (612).

5. The electric cooker with the stirring function according to claim 2, characterized in that a first fixing piece (4) is disposed on the inner pot (2) towards the driven pulley (62), and a plurality of inserting blocks (41) are disposed on the first fixing piece (4) along a circumferential direction; and a second fixing piece (5) is disposed on the housing (1) towards the first fixing piece (4), first inserting grooves (51) are formed in the second fixing piece (5) corresponding to the inserting blocks (41), and movement of the first fixing piece (4) allows the inserting blocks (41) to be inserted into the first inserting grooves (51), so as to limit rotation of the inner pot (2) relative to the housing (1).

6. The electric cooker with the stirring function according to claim 5, characterized in that second inserting grooves (52) are formed in bottoms of the first inserting grooves (51), and depth directions of the second inserting grooves (52) are along a circumferential direction of the second fixing piece (5); and rotation of the first fixing piece (4) allows the inserting blocks (41) to be inserted into the second inserting grooves (52), so as to limit disengagement of the inner pot (2) from the housing (1).

7. The electric cooker with the stirring function according to claim 6, characterized in that notches of the first inserting grooves (51) are flared.

8. The electric cooker with the stirring function according to claim 1, characterized in that the stirrer (21) and the stirring shaft (22) are detachably connected in a splicing manner through a spline shaft.

9. The electric cooker with the stirring function according to claim 8, characterized in that a pull ring (211) convenient for a person to pull out the stirrer (21) is fixed at an end, facing away from the stirring shaft (22), of the stirrer (21).

10. The electric cooker with the stirring function according to claim 1, characterized in that the transmission belt (7) is a synchronous belt, and both the driving pulley (121) and the driven pulley (62) are synchronous pulleys matched with the transmission belt (7).
